(19) United States
(12) Patent Application Publication
(10) Pub. No.: US 2009/0201216 A1
(43) Pub. Date: Aug. 13, 2009

(54) SEALED ANTENNA SYSTEM, IN PARTICULAR MOTOR-VEHICLE ROOF ANTENNA WITH PRESSURE EQUALIZATION

(76) Inventor: Christian Gerneth, Kirchentellinsfurt (DE)

Correspondence Address: K.F. ROSS P.C., 5683 RIVERDALE AVENUE, SUITE 203 BOX 900, BRONX, NY, 10471-0900, US

(21) Appl. No.: 12/367,569

(22) Filed: Feb. 9, 2009

(30) Foreign Application Priority Data
Feb. 9, 2008 (DE) 102008008404.2

(51) Int. Cl. H01Q 1/42

(52) U.S. Cl. 343/872

(57) ABSTRACT

The invention relates to an antenna assembly of a vehicle that is arranged and fastened on a mounting surface (11) and comprises a base plate (2) facing the mounting surface (11), with at least one antenna element mounted on top of or on the base plate (2), and with a housing (1) for the protection of the at least one antenna element from external influences being provided and fastened in a sealing manner on the base plate (2), which invention provides that the antenna assembly comprises means for equalizing pressure between the interior of the housing (1) and the environment outside the antenna assembly.

The invention relates to a motor-vehicle antenna assembly that is arranged and fastened on a mounting surface and that has a base plate facing the mounting surface and in or on which is mounted at least one antenna element and where furthermore a housing for the protection of the at least one antenna element from external influences is mounted in a sealing manner on the base plate, in accordance with the features of the introductory clauses of claim 1.

Such antenna assemblies of vehicles, especially roof antennas of automobiles, are known. One or more antenna elements designed, e.g. for services such as telephone, navigation, radio, television and the like are mounted on top of or on a base plate consisting for example, of zinc die-cast metal. In order to protect these sensitive antenna assemblies from external influences such as moisture as well as mechanical influences, the antenna assembly comprises a housing sealed against the mounting surface and/or against the base plate, especially at its edge. The housing consists as a rule of plastic and can be shaped in accordance with the design requirements at the mounting site. The antenna assembly is arranged and fastened with the base plate on the mounting surface, for example, a vehicle roof. The fastening can take place, for example, in a known manner by adhesion, for which embodiments are also known in which the base plate comprises a shaped threaded stem that is inserted in an opening in the mounting surface and provided on the opposite side with an attachment formation. These fastening possibilities are only by way of example, so that it is also worth mentioning that there are also other fastening possibilities. In the case of a formed threaded stem a seal is provided around it between the base plate and the mounting surface in order to prevent moisture from penetrating from the outside (from outside the vehicle) into the interior (vehicle passenger compartment). In such a case an open antenna system (antenna assembly) is present, so that the same pressure prevails inside the antenna assembly (inside the housing) and in the vehicle passenger compartment. This means that moisture can also readily penetrate from the vehicle passenger compartment into the interior of the antenna assembly. However, this has the disadvantageous effect that water can condense or precipitate inside the antenna assembly, during which a very large amount of such water can form in a disadvantageous manner as a consequence of strong temperature differences between the passenger space of the vehicle and the outside. However, this moisture inside the antenna assembly has an adverse effect on the functioning of the antenna elements and in the worst case in their failure, which is not desirable. On the whole, there is the disadvantage that in this antenna system that is completely open to pressure its structural parts such as antenna elements, seals and the like are heavily stressed by the penetrating moisture or by moisture forming as a consequence of pressure differences (condensed water), which results in a diminution of the service life of the entire antenna assembly.

In order to avoid these disadvantageous effects of the open pressure system, the provision of a completely pressure-closed antenna system has already been thought of. This takes place, for example, in that the entire interior of the housing is cast with an appropriate material after the mounting of the antenna elements. However, this represents on the one hand an elevated cost and leads to an increase in weight and means on the other hand that no more possibilities for repair are given. Furthermore, it is necessary in casting of the interior of the housing of the antenna assembly that the antenna elements be coordinated with this cast mass since the latter acts in a high-frequency manner as a dielectric. If other measures are taken for achieving a pressure-tight system, the expense is extremely high for coordinating the participating seals with the other elements (on the one hand, e.g. a metallic vehicle roof and on the other hand the plastic housing) in order to achieve a complete seal against pressure. Such an antenna system sealed by seals against the outside can therefore be manufacture only at very high expense for structural parts and consequently with an undesirably high cost.

The object of the invention is therefore to provide a motor-vehicle antenna assembly that, in addition to simple construction, has an elevated service life and avoids the initially described disadvantages.

This problem is solved by the features of claim 1.

The invention provides that the antenna assembly comprises means for equalizing pressure between the inside of the housing and the environment outside the antenna assembly. This achieves the goal of designing a sealed antenna system (=antenna assembly) in such a manner that the pressure differentials that result from different environmental influences (such as, e.g. by pressure differences inside and outside the system) can be compensated. As a result, all of the system's structural parts, that is, all relevant structural parts of the antenna assembly, primarily the sealing parts, experience reduced stress. Moreover, the condensation of water is avoided inside the housing, in particular on the surface of the at least one antenna element, so that on the whole an increase in the service life as well as the safety of the sealed antenna system is achieved and functional disturbances are avoided. This means that with a solution in accordance with the invention no system that is completely open to pressure but also no completely sealed system has to be made available anymore, but rather known antenna assemblies can be provided, if necessary even retrofitted, with the means for equalizing pressure in order to achieve the desired advantages.

A first embodiment of the invention provides that the means for equalizing pressure between the interior of the housing and the environment outside the antenna assembly is provided in the housing. That means that pressure is equalized between the interior of the housing of the antenna assembly and the environment outside the vehicle. Here, the antenna system can be but does not have to be sealed against the vehicle passenger compartment. In particular in the instance in which the inside of the housing is not sealed against the vehicle passenger compartment, pressure is effectively equalized with the outside in order, as already described, to avoid the undesirable formation of condensation water. In this instance, for example,, the housing can have an opening from its manufacture in which the means for equalizing pressure, e.g. a membrane, is detachably or permanently mounted. For example, this means can be clipped, snapped, adhered, wedged, or the like into the opening in the housing.

Furthermore, this variant provides in accordance with the invention that the means for equalizing pressure between the interior of the housing and the environment outside the antenna assembly is formed by the housing. This means in this instance that, for example, the membrane is not a separate structural part but rather is formed by the housing. It can be considered here, for example, that the housing and the membrane are manufactured in a plastic injection-molding process in which the housing consists of a different plastic that the membrane to be formed (two-component injection molding process).

Another variant of the invention provides in accordance with the invention that the means for equalizing pressure between the interior of the housing and environment outside the antenna assembly is provided in the base plate. The same also applies here as in the arrangement of the means for equalizing pressure in the housing, namely that the means for equalizing pressure such as, e.g. once again a membrane, is inserted as a separate structural part in the base plate or is formed by the base plate. In this instance a base plate can especially advantageously consist of plastic and is also produced in a two-component injection molding process for the realization of the membrane. If the means for equalizing pressure are provided in the base plate, it can be considered that pressure is equalized either between the interior of the housing of the antenna assembly and the environment outside the vehicle or, however, between the interior of the housing of the antenna assembly and the vehicle passenger compartment. In the last-cited instance the invention provides that the means for equalizing pressure between the interior of the housing and the environment outside the antenna assembly is provided in the base plate near a threaded stem formed on the base plate. The base plate is inserted through an opening in its structural surface with the threaded stem, that is also designed for running cables through it, and fixed on the opposite side, for example, with a fastening nut in order to arrange and fasten the antenna assembly on the vehicle roof. This means again that as a consequence of the opening in the threaded stem and the opening in the mounting surface a passage is formed between the interior of the housing and the vehicle passenger compartment, which means is provided for equalizing pressure in this passage.

A further variant of the invention provides that the means for equalizing pressure between the interior of the housing and the environment outside the antenna assembly is integrated in a seal of the antenna assembly. Thus, a further possibility of housing the means in accordance with the invention, for example, the membrane, is available, because in known systems the circumferential edge of the housing of the antenna assembly is frequently sealed with seals against the mounting surface so that there is the opportunity of housing the means for equalizing pressure in this sealing area in order to realize an equalization of pressure between the interior of the housing and the environment outside the antenna assembly.

The antenna assembly is constructed in an especially preferred manner as a motor-vehicle roof antenna so that the antenna assembly, which can be assembled in advance, can be mounted on a vehicle roof as a mounting surface. Furthermore, there is the advantage that roof antenna assemblies that are already known can be retrofitted if desired with the means in accordance with the invention for equalizing pressure.

The means for equalizing pressure is constructed in an especially preferred manner between the interior of the housing and the environment outside the antenna assembly as a membrane.

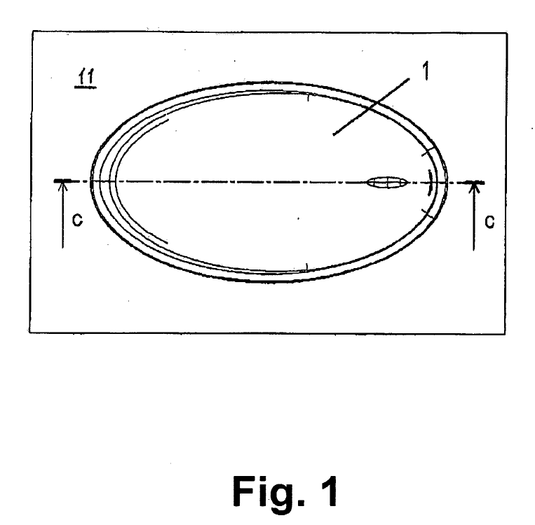

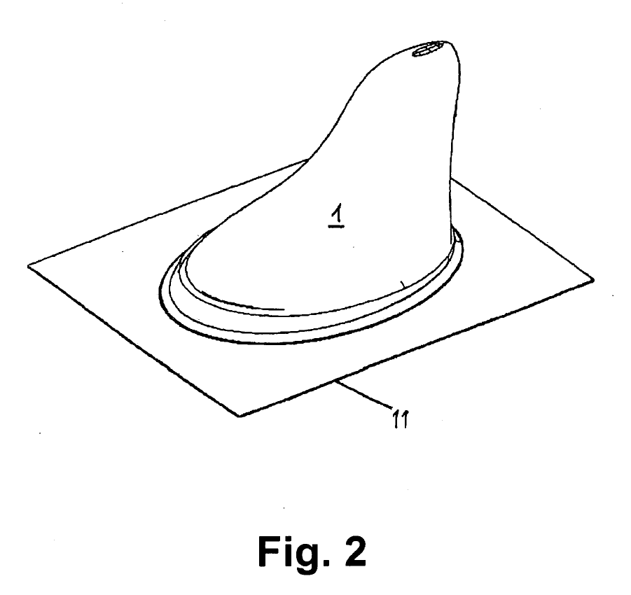

The embodiments according to FIGS. 1 to 4 show, in as far as they are shown in detail, in FIG. 1 a plan view of the antenna assembly, preferably of a motor-vehicle roof antenna on a mounting surface. FIG. 2 shows an embodiment of such a roof antenna in a three-dimensional view.

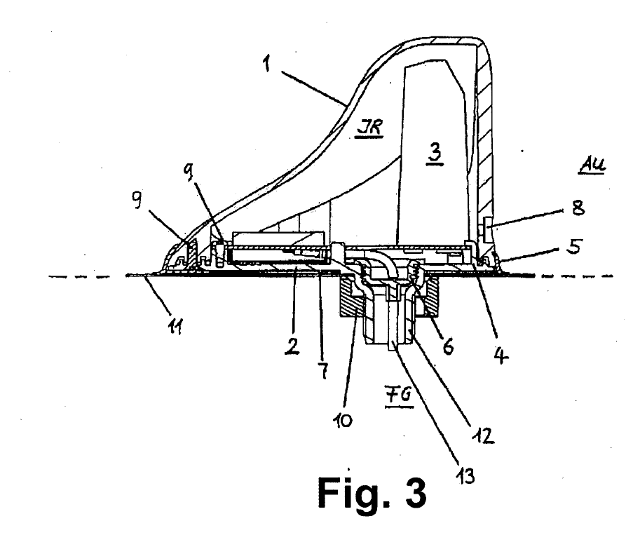

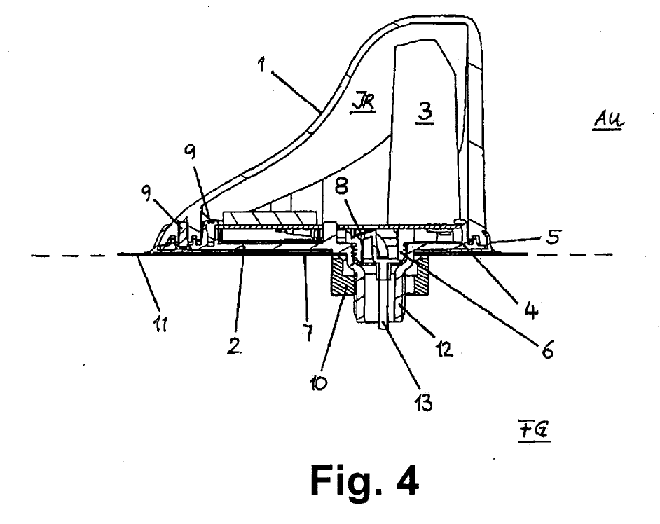

FIGS. 3 and 4 show an embodiment for the provision of the means in accordance with the invention for equalizing pressure on section line C-C of FIG. 1.

FIGS. 3 and 4 show, in as far as shown in detail, a housing 1 and a base plate 2 of an antenna assembly (designated in the following as a roof antenna). The housing 1 is made, for example, of plastic and the base plate 2 can but does not have to be made of metal (e.g. zinc die-cast metal). At least one antenna element, frequently even more than two antenna elements, is mounted on top of or on the base plate 2. These antenna elements are formed, for example, by a printed circuit board 3 whose surface carries appropriate antenna structures of copper conducting traces.

Furthermore, the roof antenna has an inner seal 4, a seal support 5, a cable seal 6 as well as a mounting hole seal 7.

In accordance with the invention, according to FIG. 3 the means for equalizing pressure between the interior of housing 1 and the outside is provided in the form of a membrane 8 in housing 1. In the variant of the roof antenna shown in FIG. 3 the membrane 8 is provided on the housing 1 in a region facing away from the travel wind in order to be able to achieve an effective equalization of pressure even when moving. It is furthermore conceivable to insert the membrane 8 into an opening of the housing 1 such that it not only serves to receive the membrane 8 but also via which fastening means can also be actuated in order to mount the roof antenna on the mounting surface. Reference numeral 9 designates fastening screws with which the base plate 2 is fastened to the housing 1. Reference numeral 10 designates a fastening nut 10 with which the roof antenna is fastened (fixed), after having been provided with it's the base plate 2 on a mounting surface 11, on the bottom of mounting surface 11 via a formed threaded stem 12. The threaded stem 12 has an inner bore through which cables 13 connected to the antenna elements can be run to an electrical device such as, e.g. an antenna amplifier connected to their outer ends.

The seals 4 to 7 form a seal but not a pressure-tight one for the respective structural elements from the outside and with respect the vehicle passenger compartment in order to prevent the penetration of rainwater, wash water, particles of dirt and the like into the interior of the housing 1 and into the passenger compartment. These seals have a simple design and consequently are not pressure-tight so that the system is still open and pressure equalization is not realized without the means in accordance with the invention, in particular the membrane 8.

FIG. 4 shows a variant whereby the means for equalizing pressure, in particular the membrane 8, is provided in the base plate 2, more precisely near the threaded stem 12 formed on the base plate 2. Thus in this variant equalization of pressure can take place between the interior of the antenna system and a vehicle passenger compartment, as shown in FIG. 4.

Whereas in FIG. 3 pressure is equalized between the interior of the antenna system and the environment of the vehicle, use of the membrane 8 located there and in FIG. 4 equalizes pressure between the interior of the antenna system and the passenger compartment of the vehicle via the membrane 8 located there, a combination of both possibilities of pressure equalization can also be considered. It is furthermore conceivable to use more than one such membrane 8 in the housing 1 and/or in the base plate 2 (or near the base plate 2).

The base plate 2 with the threaded stem 12 shown in FIGS. 3 and 4 is only by way of example, so that should be noted that the means in accordance with the invention for equalizing pressure can also be considered for other design forms of base plates as well as for other design forms of the fastening of the roof antenna, especially of the base plate of the roof antenna, on the vehicle roof. Likewise, the means for equalizing pressure can also be provided in the base plate 2 in such a manner that pressure is not equalized with the interior or not only with that of the interior of the vehicle but rather also with respect to the environment outside the vehicle. Likewise, the means in accordance with the invention for equalizing pressure can also be provided as an alternative or supplement to the two variants shown in FIGS. 3 and e.g. in one of the seals 4 to 7, especially in the seal support 5.

### LIST OF REFERENCE NUMERALS

1 housing
2 base plate
3 printed circuit board
4 inner seal
5 seal support
6 cable seal
7 mounting hole seal
8 membrane
9 fastening screws
10 fastening nut
11 mounting surface
12 threaded stem
13 cable
IR interior of the roof antenna
AU environment outside the vehicle
FG vehicle passenger compartment

1. An antenna assembly of a vehicle that is arranged and fastened on a mounting surface and comprises a base plate facing the mounting surface, with at least one antenna element mounted in or on the base plate, and with a housing for the protection of the at least one antenna element from external influences being provided and fastened in a sealing manner on the base plate wherein the antenna assembly comprises means for equalizing pressure between the interior of the housing and the environment outside the antenna assembly.

2. The antenna assembly according to claim 1 wherein the means for equalizing pressure between the interior of the housing and the environment outside the antenna assembly is provided in the housing.

3. The antenna assembly according to claim 2 wherein the means for equalizing pressure between the interior of the housing and the environment outside the antenna assembly is formed by the housing.

4. The antenna assembly according to claim 1 wherein the means for equalizing pressure between the interior of the housing and the environment outside the antenna assembly is provided in the base plate.

5. The antenna assembly according to claim 4 wherein the means for equalizing pressure between the interior of the housing and the environment outside the antenna assembly is provided in the base plate near a threaded stem formed on the base plate.

6. The antenna assembly according to claim 1 wherein the means for equalizing pressure between the interior of the housing and the environment outside the antenna assembly is integrated in a seal of the antenna assembly.

7. The antenna assembly according claim 1 wherein the antenna assembly is constructed as a motor-vehicle roof antenna.

8. The antenna assembly according claim 1 wherein the means for equalizing pressure between the interior of the housing and the environment outside the antenna assembly is a membrane.

9. An antenna assembly for use on an exterior mounting surface of a motor vehicle, the assembly comprising:
a base plate juxtaposed with the exterior mounting surface;
means for securing the base plate to the mounting surface;
an antenna element mounted on the base plate;
a housing engaged over the antenna element, externally exposed to the environment outside the motor vehicle, and joined to the base plate to form therewith a substantially closed interior space containing the antenna element; and
means for equalizing pressure between the interior and the outside environment.

10. The motor-vehicle antenna assembly defined in claim 9 wherein the pressure-equalizing means is provided on the housing.

11. The motor-vehicle antenna assembly defined in claim 10 wherein the pressure-equalizing means is part of the housing.

12. The motor-vehicle antenna assembly defined in claim 9 wherein the pressure-equalizing means is provided in the base plate.

13. The motor-vehicle antenna assembly defined in claim 12 wherein the securing means includes a threaded stem extending from the base plate through a hole in the mounting surface, the pressure-equalizing means being provided at the hole.

14. The motor-vehicle antenna assembly defined in claim 9, further comprising
a seal between an edge of the housing and the base plate, the pressure-equalizing means being integrated into the seal.

15. The motor-vehicle antenna assembly defined in claim 9 wherein exterior mounting surface is a motor-vehicle roof.

16. The motor-vehicle antenna assembly defined in claim 1 wherein the pressure-equalizing means is a membrane.

17. The motor-vehicle antenna assembly defined in claim 9 wherein the housing or the base plate is formed with a throughgoing hole and the pressure-equalizing means is a membrane covering the hole.

18. The motor-vehicle antenna assembly defined in claim 17 wherein the hole is in the housing.

19. The motor-vehicle antenna assembly defined in claim 9 wherein the housing is downwardly cup-shaped and the assembly further comprises
screws securing the housing downward on the base plate.
